(19) United States
(12) Patent Application Publication
(10) Pub. No.: US 2024/0391435 A1
(43) Pub. Date: Nov. 28, 2024

(54) PEDAL SIMULATOR

(71) Applicant: HL MANDO CORPORATION, Gyeonggi-do (KR)

(72) Inventors: Soo Yong JEON, Gyeonggi-do (KR); Hyun Dong KIM, Gyeonggi-do (KR); Jiyun PARK, Gyeonggi-do (KR)

(21) Appl. No.: 18/695,361

(22) PCT Filed: Sep. 29, 2022
(86) PCT No.: PCT/KR2022/014669

§ 371 Date: Mar. 26, 2024

(30) Foreign Application Priority Data
Sep. 29, 2021 (KR) 10-2021-0129207
Sep. 29, 2021 (KR) 10-2021-0129283
Sep. 29, 2021 (KR) 10-2021-0129284
Sep. 28, 2022 (KR) 10-2022-0123838

(51) Int. Cl. B60T 8/40; B60T 7/04; B60T 17/22

(52) U.S. Cl. CPC B60T 8/40; B60T 7/04; B60T 17/22

(57) ABSTRACT

A pedal simulator including a cylinder body having an internal space formed as one side is opened, and the other side is closed, a piston configured to move forward and rearward in the internal space of the cylinder body by an operation of a pedal, a damper provided in the internal space of the cylinder body and configured to transfer pedal feel to an electric booster by means of a pressure applied from the piston, a push rod having one side connected to the pedal, and the other side connected to the piston, the push rod being configured to move the piston forward toward the damper by the operation of the pedal, and a return means provided while covering one side of the cylinder body and a part of the push rod and configured to provide a restoring force for moving rearward the push rod that has moved forward.

### CROSS-REFERENCE TO RELATED APPLICATIONS

This application is the U.S. National Stage of International Patent Application No. PCT/KR2022/014669 filed on Sep. 29, 2022, which claims priority to and benefit of Korean Patent Application No. 10-2021-0129207, filed on Sep. 29, 2021, Korean Patent Application No. 10-2021-0129283, filed on Sep. 29, 2021, Korean Patent Application No. 10-2021-0129284, filed on Sep. 29, 2021, and Korean Patent Application No. 10-2022-0123838, filed on Sep. 28, 2022, the disclosures of which are incorporated herein by reference in their entirety.

### TECHNICAL FIELD

The present disclosure relates to a pedal simulator, and more particularly, to a pedal simulator configured to transmit a pedal operation of a driver to an electric control system and provide a reaction force to the driver.

### BACKGROUND ART

A vehicle is essentially equipped with a brake system for braking the vehicle. Various types of brake systems have been proposed to provide safety for a driver and a passenger.

The brake system in the related art mainly operates in such a way that when the driver pushes a brake pedal, a booster mechanically connected to the brake pedal is used to supply a wheel cylinder with a liquid pressure required to brake the vehicle.

However, as there is an increasing demand from the market to implement various braking functions in order to appropriately cope with operational environments of vehicles, electronic brake systems have recently widely proliferated, in which when a driver pushes a brake pedal, a pedal displacement sensor, which detects a displacement of the pedal, transmits an electrical signal to indicate a driver's intention to brake, and a liquid pressure supply device operates in response to the electrical signal to supply a wheel cylinder with a liquid pressure required to brake the vehicle.

The electronic brake system is equipped with a simulator provided in an electric booster and configured to create braking performance. The simulator creates the braking performance by using a pressure generated as a force, which is transmitted when the driver pushes the brake pedal, operates a master cylinder.

However, because the simulator in the related art is provided in the electric booster as described above, a shape of the electric booster needs to be inevitably changed when the braking performance is intended to be changed. However, a large volume of the electric booster causes a limitation in configuring an engine room, and a heavy weight of the electric booster requires that a firewall in the vehicle has high rigidity. As described above, there are many limitations in changing the braking performance of the simulator.

### DISCLOSURE

### Technical Problem

An object of the present disclosure is to provide a pedal simulator that is separated from an electric control system, which may improve a degree of installation freedom and prevent the occurrence of impact and noise, the pedal simulator being capable of transmitting a pedal operation of a driver to the electric control system and providing a reaction force to the driver.

### Technical Solution

An embodiment of the present disclosure provides a pedal simulator including: a cylinder body having an internal space formed as one side is opened, and the other side is closed; a piston configured to move forward and rearward in the internal space of the cylinder body in conjunction with an operation of a pedal; a damper provided in the internal space of the cylinder body and configured to transfer pedal feel to an electric booster by means of a pressure applied from the piston; a push rod having one side connected to the pedal, and the other side connected to the piston, the push rod being configured to move the piston forward toward the damper in conjunction with the operation of the pedal; and a return means provided while covering one side of the cylinder body and a part of the push rod and configured to provide a restoring force for moving rearward the push rod that has moved forward.

In addition, the return means may include: a first elastic member connected to one side of the cylinder body while covering the push rod and configured to move the push rod rearward by an elastic force; a boot coupled to one side of the cylinder body while covering the first elastic member and configured to be contracted and expanded by the forward and rearward movements of the piston; and a retainer penetrated by the push rod and coupled to block one side of the boot.

In addition, one or more vent holes may be formed in the retainer to allow the inside and outside of the boot so that air in the boot is discharged or outside air is introduced into the boot.

In addition, the cylinder body may further include blade portions extending from an outer peripheral surface of the cylinder body in a direction intersecting a longitudinal direction of the cylinder body, and the blade portions may be provided as a pair of blade portions formed to be symmetric based on a central axis that penetrates the cylinder body in the longitudinal direction of the cylinder body.

In addition, a through-hole may be formed in the blade portion in a direction parallel to the longitudinal direction of the cylinder body.

In addition, the pedal simulator may further include: a fastening member penetratively inserted in the through-hole and configured to fix the cylinder body to a vehicle.

In addition, the fastening member may include: a head portion partially penetratively inserted in the through-hole; and an insertion fixing portion extending from one surface of the head portion and inserted in the vehicle to fix the cylinder body.

In addition, the pedal simulator may further include: a ventilation means configured to allow air to flow in accordance with a change in volume of the internal space of the cylinder body and a change in volume of and the boot when the piston moves forward and rearward.

In addition, the ventilation means includes a vent flow path formed in any one of the cylinder body and the piston.

In addition, the vent flow path may be formed in an inner peripheral surface of the cylinder body, and the vent flow path may be formed in the form of a slot concavely formed by a preset length toward the other side of the cylinder body from a position spaced apart from one side of the cylinder body by a preset distance.

Another embodiment of the present disclosure provides a pedal simulator including: a cylinder body having a hole portion formed through the cylinder body in a longitudinal direction; a piston inserted in one side of the hole portion of the cylinder body and configured to move forward and rearward in conjunction with an operation of a pedal; a cover member inserted in the other side of the hole portion of the cylinder body to block the other side of the cylinder body; a damper coupled to the cover member and provided in the hole portion of the cylinder body to transfer pedal feel to an electric booster by means of a pressure applied from the piston; a push rod having one side connected to the pedal, and the other side connected to the piston, the push rod being configured to move the piston forward toward the damper in conjunction with the operation of the pedal; and a return means provided while covering one side of the cylinder body and a part of the push rod and configured to provide a restoring force for moving rearward the push rod that has moved forward.

In addition, the hole portion may include: a first hole formed through the cylinder body by a preset length from one side toward the other side of the cylinder body in the longitudinal direction of the cylinder body; and a second hole formed through the cylinder body from an end of the first hole to the other side of the cylinder body, and a cross-section of the second hole intersecting the longitudinal direction of the cylinder body may be larger than a cross-section of the first hole intersecting the longitudinal direction of the cylinder body.

In addition, the return means may include: a first elastic member connected to one side of the cylinder body while covering the push rod and configured to move the push rod rearward by an elastic force; a boot coupled to one side of the cylinder body while covering the first elastic member and configured to be contracted and expanded by the forward and rearward movements of the piston; a retainer configured to penetrate the push rod and coupled to block one side of the boot; and a second elastic member having one side connected to the piston while covering the damper, and the other side connected to the cover member and provided in the second hole, the second elastic member being configured to move the piston rearward by an elastic force.

In addition, the pedal simulator may further include: a ventilation means provided to allow air to flow in accordance with a change in volume of a hole portion of the cylinder body and a change in volume of the boot by the forward and rearward movements of the piston.

In addition, the ventilation means may further include a first vent flow path formed in any one of the cylinder body and the piston so that air in the hole portion of the cylinder body flows into the return means when the piston moves forward, or air in the boot flows to the hole portion of the cylinder body when the piston moves rearward.

In addition, the ventilation means may further include a second vent flow path extending from one side of the cylinder body in the longitudinal direction of the cylinder body and formed through an outer peripheral surface of the cylinder body so that when the piston moves forward, air in the boot is discharged to the outside or outside air is introduced into the boot.

In addition, the ventilation means may further include a third vent flow path penetratively formed from the hole portion of the cylinder body to the outside so that when the piston moves forward, air in the hole portion of the cylinder body is discharged to the outside or outside air is introduced into the hole portion of the cylinder body.

In addition, the ventilation means may further include a filter member provided while covering an outer peripheral surface of the cylinder body so as to cover the second vent flow path and the third vent flow path, the filter member being configured to remove foreign substances in air.

In addition, the pedal simulator may further include: a stopper member provided between the piston and the first hole and configured to absorb an impact and prevent noise when the impact and noise are generated by the forward and rearward movements of the piston.

In addition, the cylinder body may further include blade portions extending from an outer peripheral surface of the cylinder body in a direction intersecting a longitudinal direction of the cylinder body, and the blade portions may be provided as a pair of blade portions formed to be symmetric based on a central axis that penetrates the cylinder body in the longitudinal direction of the cylinder body.

Other detailed matters of the exemplary embodiment are included in the detailed description and the drawings.

### Advantageous Effects

The pedal simulator according to the present disclosure may have the following effects.

First, the pedal simulator separated from the electric control system (electric booster) may be implemented, thereby improving a degree of installation freedom in the engine room.

Second, because the pedal simulator is separated from the electric control system (electric booster), such that the sizes, which may correspond to various braking performances, are freely deformed.

Third, the ventilation means may be provided, thereby preventing noise from being generated by a flow of air when the pedal simulator operates.

Fourth, the stopper member may be provided, thereby absorbing an impact and preventing noise when the impact and noise are generated when the pedal simulator operates.

### DESCRIPTION OF DRAWINGS

FIG. 1 is a cross-sectional view illustrating a pedal simulator according to an embodiment of the present disclosure.

FIG. 2 is an enlarged cross-sectional view of a part of the pedal simulator in FIG. 1.

FIG. 3 is a cross-sectional view made in a direction intersecting the pedal simulator illustrated in FIG. 1.

FIG. 4 is a partial perspective view illustrating a structure in which a part of a cylinder body and a fastening member are coupled.

FIG. 5 is a perspective view illustrating the fastening member.

FIG. 6 is an exploded perspective view of a pedal simulator according to another embodiment of the present disclosure.

FIG. 7 is a cross-sectional view of the pedal simulator in FIG. 6.

FIG. 8 is a partial cross-sectional view of the pedal simulator in FIG. 6.

FIG. 9 is a perspective view of a stopper member.

FIGS. 10 and 11 are partial cross-sectional views illustrating a ventilation means.

### MODE FOR INVENTION

Hereinafter, embodiments of the present disclosure will be described in detail with reference to the accompanying drawings so that those with ordinary skill in the art to which the present disclosure pertains may easily carry out the embodiments. The present disclosure may be implemented in various different ways, and is not limited to the embodiments described herein.

It is noted that the drawings are schematic and are not illustrated based on actual scales. Relative dimensions and proportions of parts illustrated in the drawings are exaggerated or reduced in size for the purpose of clarity and convenience in the drawings, and any dimension is just illustrative but not restrictive. The same reference numerals designate the same structures, elements or components illustrated in two or more drawings in order to exhibit similar characteristics.

Embodiments of the present disclosure illustrate ideal embodiments of the present disclosure in detail. As a result, various modifications of the drawings are expected. Therefore, the embodiments are not limited to specific forms in regions illustrated in the drawings, and for example, include modifications of forms by the manufacture thereof.

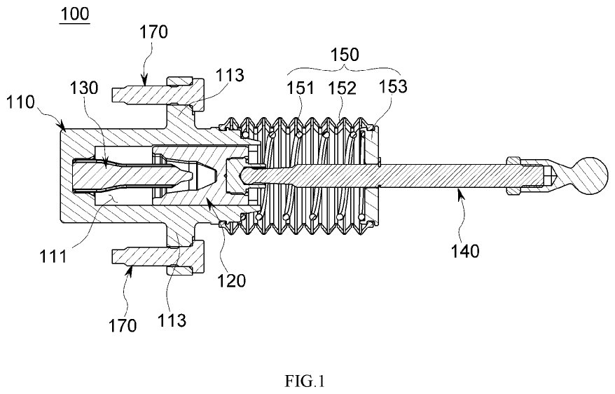

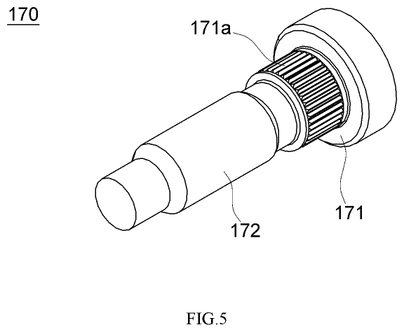

Hereinafter, a pedal simulator according to the present disclosure will be described in detail with reference to FIGS. 1 to 5.

A pedal simulator 100 according to an embodiment of the present disclosure includes a cylinder body 110, a piston 120, a damper 130, a push rod 140, a return means 150, and a ventilation means 160.

The cylinder body 110 has an internal space 111. With reference to FIG. 1, in the present embodiment, the cylinder body 110 is formed in a shape in which one side is opened, and the other side is closed.

The cylinder body 110 includes blade portions 113. The blade portions 113 are formed to mount the pedal simulator 100 in a vehicle. The blade portions 113 protrude from an outer peripheral surface of the cylinder body 110. The blade portions 113 extend in a direction intersecting a longitudinal direction of the cylinder body 110. The blade portions 113 are formed as a pair of blade portions 113 formed to be symmetric with respect to a central axis parallel to the longitudinal direction of the cylinder body 110.

The blade portion 113 may be formed in a plate shape having a preset thickness. However, the shape of the blade portion 113 is not limited, and the blade portion 113 may be formed in various shapes. The blade portion 113 has a through-hole 113a formed through the blade portion 113 in a thickness direction parallel to the longitudinal direction of the cylinder body 110. Fastening members 170 are coupled to the through-holes 113a. The fastening member 170 will be described below.

The internal space 111 is configured by a groove (not illustrated) formed concavely by a preset length from one side to the other side of the cylinder body 110. In the present embodiment, the concave groove (not illustrated) has a uniform cross-section intersecting the longitudinal direction of the cylinder body 110.

A damper coupling groove (not illustrated) is formed in an inner surface of the groove (not illustrated) and formed to be concave toward the other side of the cylinder body 110 so that the damper 130 to be described below may be coupled.

The piston 120 is provided in the internal space 111 of the cylinder body 110. Specifically, the piston 120 is provided to move forward and rearward in the internal space 111 of the cylinder body 110.

The piston 120 does not autonomously move forward and rearward. The piston 120 is moved forward by the push rod 140 and moved rearward by the return means 150.

When the piston 120 moves forward, the other side of the piston 120 comes into contact with the damper 130. A damper coupling groove (not illustrated), which has a shape identical to a shape of the damper 130, is formed at the other side of the piston 120. Therefore, when the piston 120 moves forward, one side of the damper 130 is inserted into the damper coupling groove (not illustrated).

One side of the push rod 140 is connected to a pedal (not illustrated), and the other side of the push rod 140 is connected to the piston 120. The push rod 140 operates in conjunction with an operation of the pedal (not illustrated). When a driver pushes the pedal (not illustrated) and applies a pressure, the push rod 140 is moved (pushed) forward, and the piston 120 is moved forward in conjunction with this operation.

The damper 130 is provided in the internal space 111 of the cylinder body 110. The damper 130 transfers pedal feel to an electric booster (not illustrated) through a pressure applied from the piston 120.

When the piston 120 moves forward as described above, the piston 120 comes into contact with the damper 130 and applies a pressure to the damper 130. Further, the damper 130 transfers the pedal feel to the electric booster (not illustrated) through the applied pressure. An electronic brake (not illustrated) is equipped with a pressure sensor (not illustrated), and the pressure sensor (not illustrated) measures the pressure applied to the damper 130.

In addition, it is possible to determine whether the damper 130 is damaged or broken on the basis of a value of the pressure applied by the damper 130 and measured by the pressure sensor (not illustrated). For example, a pressure equal to or higher than a preset value needs to be measured from the damper 130. However, the pressure equal to or higher than the preset value is not measured, it is possible to determine that the damper 130 is damaged or broken.

Meanwhile, although not illustrated in the drawings, the damper 130 may be equipped with a force sensor. The force sensor (not illustrated) may directly measure the pressure applied to the damper 130, and thus whether the damper 130 is damaged may be identified.

The piston 120, which has been moved forward, is returned to an initial position by the return means 150. The return means 150 is provided while surrounding a part of the push rod 140 at a side at which one side of the cylinder body 110 and the piston 120 are connected.

The return means 150 includes a first elastic member 151, a boot 152, and a retainer 153. One side of the first elastic member 151 is fitted with and coupled to an outer peripheral surface of one side of the cylinder body 110. The push rod 140 penetrates the first elastic member 151 and is coupled to the piston 120. Therefore, the first elastic member 151 is provided to surround the push rod 140.

In the present embodiment, a spring is applied as the first elastic member 151, but the present disclosure is not limited thereto. The first elastic member 151 is compressed when the push rod 140 is moved forward by the pressure applied from the pedal (not illustrated). When the pressure, which is applied from the pedal (not illustrated), is eliminated, the first elastic member 151 generates a tensile force that restore the first elastic member 151 to an initial state, such that the push rod 140 is moved rearward. Further, the piston 120 connected to the push rod 140 also moves rearward.

The boot 152 is provided while surrounding the first elastic member 151. One side of the boot 152 is also coupled to one side of the cylinder body 110. The boot 152 is formed in a corrugated pipe so that the boot 152 is folded when the first elastic member 151 is compressed, and the boot 152 is unfolded when the first elastic member 151 is stretched.

The retainer 153 is coupled to the other side of the boot 152. The retainer 153 is fixed to the push rod 140 while blocking the other side of the boot 152. A hole (not illustrated) is formed in the retainer 153, and the push rod 140 penetrates the retainer 153. Because the retainer 153 is fixed to the push rod 140, the boot 152 may be folded when the push rod 140 moves forward, and the boot 152 may be unfolded when the push rod 140 moves rearward.

The retainer 153 has a vent hole 153a. The vent hole 153a allows the inside and outside of the boot 152 to communicate with each other. Air in the boot 152 may be discharged to the outside through the vent hole 153a, or outside air may be introduced into the boot 152 through the vent hole 153a. The vent hole 153a may be provided as a plurality of vent holes 153a spaced apart from one another by a preset angle in a circumferential direction of the retainer 153.

The ventilation means 160 is provided so that air is allowed to flow by a change in a volume of the internal space 111 of the cylinder body 110 and a change in a volume of the boot 152 when the piston 120 moves forward and rearward. Specifically, the ventilation means is formed so that the air in the internal space 111 of the cylinder body 110 moves into the boot 152 or the air in the boot 152 moves to the internal space 111 of the cylinder body 110.

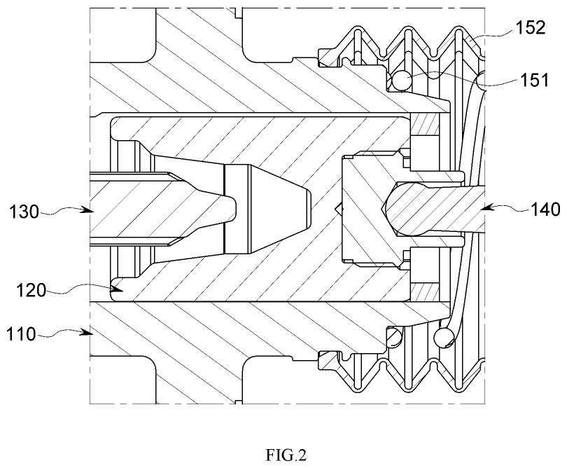

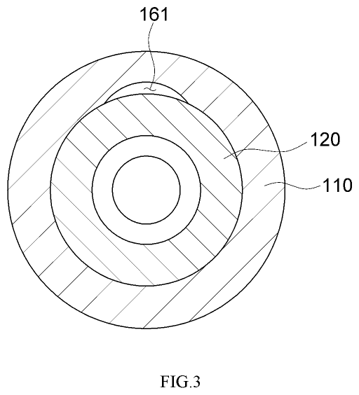

FIGS. 2 and 3 illustrate one embodiment of the ventilation means 160.

The ventilation means 160 includes a vent flow path 161 formed in any one of the cylinder body 110 and the piston 120.

The vent flow path 161 may be formed in the cylinder body 110. Specifically, the vent flow path is formed in the form of a concave slot formed toward the other side of the cylinder body 110 from a position spaced apart from one side of the cylinder body 110 toward the other side of the cylinder body 110 by a preset distance (see FIG. 3).

A vent flow path (not illustrated) having another shape may be formed in the piston 120. Specifically, the vent flow path may be formed in an outer peripheral surface of the piston 120 and formed in the form of a concave slot formed from one side to the other side of the piston 120.

When the piston 120 moves forward after the piston 120 is inserted into the cylinder body 110, a volume of the internal space 111 of the cylinder body 110 decreases. Therefore, the air, which stays in the internal space 111 of the cylinder body 110, flows into the boot 152 through the vent flow path 161. In contrast, a volume of the boot 152 decreases when the piston 120 moves rearward. Therefore, the air, which stays in the boot 152, flows to the internal space 111 of the cylinder body 110 through the vent flow path 161.

The ventilation means 160 generates an appropriate pressure in the boot 152 and the internal space 111 of the cylinder body 110 when the piston 120 moves forward and rearward, such that the boot 152 is prevented from being irregularly folded, and a delay of the return of the piston 120 is prevented. That is, the air flows smoothly in the boot 152 and the internal space of the cylinder body 110 when the piston 120 moves forward and rearward, such that the occurrence of noise may be prevented.

The pedal simulator 100 is installed in a vehicle (not illustrated) by the fastening members 170. As described above, the fastening members 170 are penetratively inserted into the through-hole 113a formed in the blade portion 113. When the pedal simulator 100 is intended to be installed in the vehicle (not illustrated), the cylinder body 110 is fixed to the vehicle (not illustrated) and the pedal simulator 100 is installed in the vehicle (not illustrated) only by inserting the fastening member 170 into the vehicle (not illustrated).

Meanwhile, the cylinder body 110 is manufactured by insert-injection molding in a state in which the cylinder body 110 includes the fastening members 170.

In the present embodiment, the cylinder body 110 is made of a plastic material. In the related art, a cylinder body is made of a metallic material such as aluminum or steel, and a fastening member is coupled to the cylinder body by press-fitting. However, in the present embodiment, as described above, the cylinder body is made of a plastic material, such that there is a risk in that the blade portion 113 is damaged during the process of press-fitting the fastening member 170. Therefore, the cylinder body 110 is manufactured by insert-injection molding in the state in which the cylinder body 110 includes the fastening members 170, thereby ensuring the quality and durability of the cylinder body 110.

The fastening member 170 includes a head portion 171 and an insertion fixing portion 172. The head portion 171 is a portion inserted into the through-hole 113a of the blade portion 113. Protrusions 171a are formed on an outer peripheral surface of the head portion 171. The protrusions 171a are continuously formed in a circumferential direction of the head portion 171. The protrusions 171a reduce a contact area between the fastening member 170 and the blade portion 113.

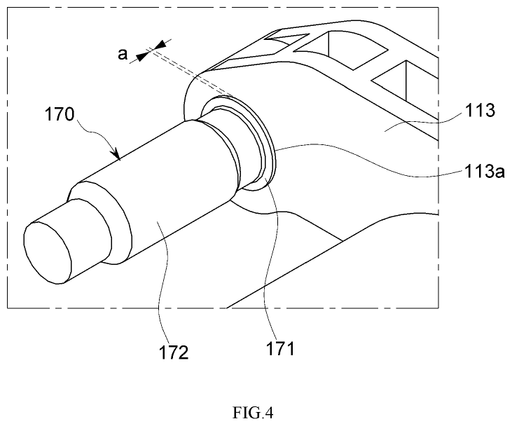

The insertion fixing portion 172 extends from one surface of the head portion 171. The insertion fixing portion 172 is a portion to be inserted into the vehicle (not illustrated), and the cylinder body 110 is fixed by the insertion fixing portion 172. Meanwhile, one surface of the blade portion 113 and one surface of the head portion 171, on which the insertion fixing portion 172 is formed, has a stepped portion a formed by a preset interval (see FIG. 4).

In case that the blade portion 113 is in direct contact with the vehicle (not illustrated) when the pedal simulator 100 is installed in the vehicle (not illustrated), a load, which is applied during the installation process, is transmitted to the blade portion 113, which may cause a concern that the blade portion 113 is damaged.

However, because the stepped portion a is provided as described above, it is possible to prevent the blade portion 113 from being in direct contact with the vehicle (not illustrated) and prevent a load, which is applied during the installation process, from being transmitted to the blade portion 113. In addition, as described above, the protrusions 171a may be formed on the head portion 171 to reduce the contact area between the head portion 171 and the blade portion 113, thereby reducing friction and the transmission of the load between the fastening member 170 and the blade portion 113.

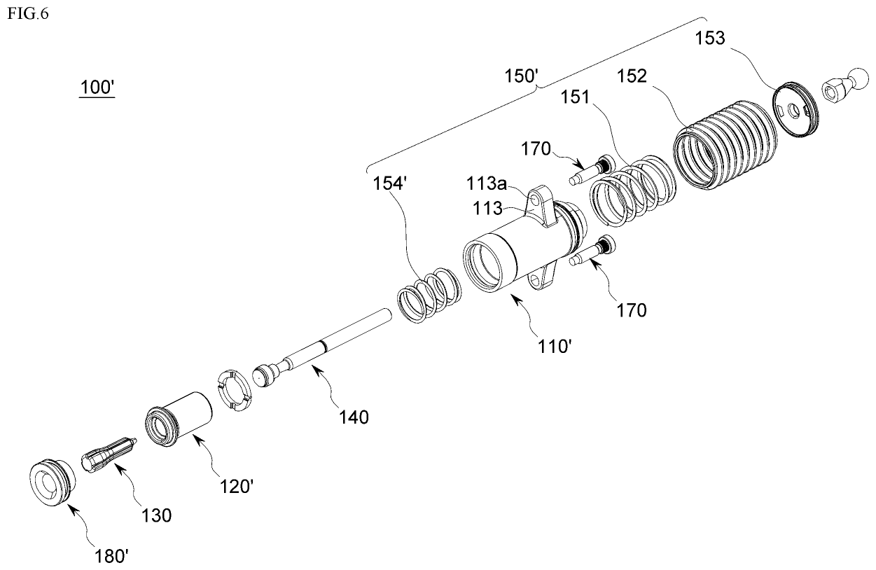

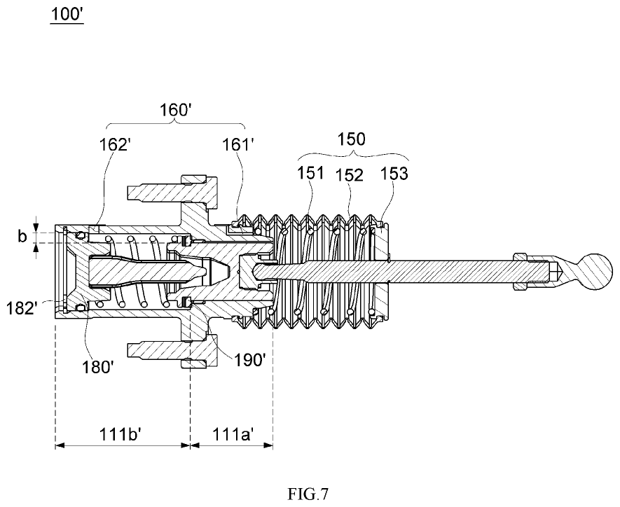

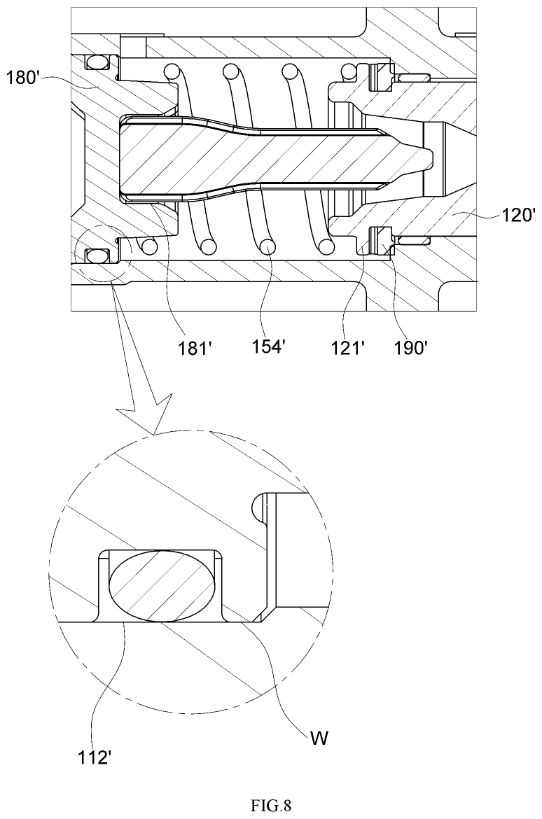

FIGS. 6 to 11 illustrate a pedal simulator 100′ according to another embodiment of the present disclosure.

The pedal simulator 100′ partially differs from the pedal simulator 100 according to the embodiment. Therefore, in the following description, only a difference will be described, and a description of common parts will be omitted.

The pedal simulator 100′ includes a cylinder body 110′, a piston 120′, the damper 130, the push rod 140, a return means 150′, and a ventilation means 160′.

The cylinder body 110′ includes a hole portion 111′ formed through the cylinder body 110′ in a longitudinal direction. The hole portion 111′ includes a first hole 111a′ formed through the cylinder body 110′ from one side toward the other side of cylinder body 110′, and a second hole 111b′ formed through the cylinder body 110′ from the first hole 111a′ toward the other side of the cylinder body 110′.

A size of a cross-section of the first hole 111a′, which intersects the longitudinal direction, is smaller than a size of a cross-section of the second hole 111b′ that intersects the longitudinal direction. Therefore, a stepped portion b is defined by a difference in size between the cross-section of the first hole 111a′ and the cross-section of the second hole 111b′.

The first hole 111a′ is a portion into which the piston 120′ is inserted and coupled. The damper 130 is provided in the second hole 111b′. Specifically, the damper is coupled to the cover member 180′ inserted into the cylinder member 110′.

In the present embodiment, the other side of the cylinder body 110′ is opened by the second hole 111b′. Therefore, the pedal simulator 100′ further includes the cover member 180′ to block the other side of the cylinder body 110′.

The cover member 180′ is inserted into the second hole 111b′ at the other side of the cylinder body 110′. A groove 181′ is formed at one side of the cover member 180′, and the other side of the damper 130 is provided in the second hole 111b′ in the state in which the other side of the damper 130 is inserted into the groove 181′.

The second hole 111b′ has a stepped groove 112′ formed at a preset position directed from the other side toward one side of the cylinder body 110′. The cover member 180′ is positioned by being caught by the stepped groove 112′. A portion W between the cover member 180′ and the stepped groove 112′ are welded, such that the cover member 180′ is fixed.

As in the above-mentioned embodiment, the cylinder body 110′ also has the blade portions 113, and the fastening members 170 are coupled to the blade portions 130. Because this configuration is identical to that in the above-mentioned embodiment, and a detailed description thereof will be omitted.

Meanwhile, a snap ring 182′ is coupled to the other side of the cylinder body 110′ and prevents the cover member 180′ from separating from the other side of the cylinder body 110′

The piston 120′ is inserted into a first hole 111′ of the cylinder body 110′, and a part of the other side of the piston 120′ is positioned in the second hole 111b′. The piston 120′ has a flange portion 121′ formed at a position spaced apart from the other side of the piston 120′ toward one side of the piston 120′ by a preset distance. The flange portion 121′ protrudes from an outer peripheral surface of the piston 120′ and extends in the circumferential direction.

The flange portion 121′ is caught by the stepped portion b when the piston 120′ is inserted into the cylinder body 110′. Therefore, the piston 120′ is prevented from separating from the cylinder body 110′.

The pedal simulator 100′ further includes a stopper member 190′. The stopper member 190′ is provided between the flange portion 121′ and the stepped portion b. The stopper member 190′ is made of a material having elasticity, absorbing an impact and reducing noise when the impact and noise occur when the piston 120′ comes into contact with the stepped portion b of the cylinder body 110′ while the piston 120′ returns after the piston 120′ moves forward.

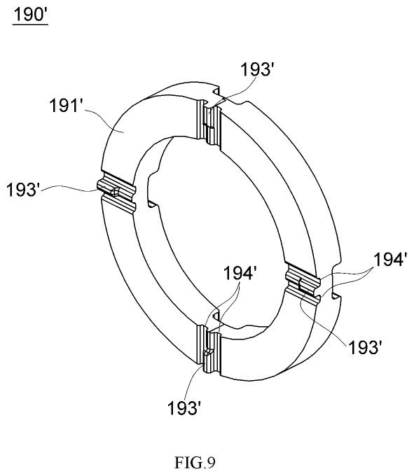

FIG. 9 illustrates the stopper member 190′. With reference to FIG. 9, the stopper member 190′ is formed in a ring shape. One surface 191′ of the stopper member is directed toward the stepped portion b, and the other surface 192′ of the stopper member is directed toward the flange portion 121′. Protrusions 193′ are formed on one surface 191′. Therefore, the protrusions 193′ are in contact with the stepped portion b.

The protrusions 193′ are provided as a plurality of protrusions 193′ formed on one surface 191′ and spaced apart from one another by a preset angle in a circumferential direction of the stopper member 190′. The protrusions 193′ are formed on the stopper member 190′, which may reduce a contact area between the stepped portion b and the piston 120′ and reduce noise that occurs when the piston 120′ is separated from the stepped portion b when the piston 120′ moves forward.

Concave grooves 194′ are formed in one surface 191′ and provided at two opposite sides based on the protrusion 193′. The groove 194′ serves as an avoidance space so that the portions having the protrusions 193′ may be easily deformed so the piston 120 and the protrusions 193′ come into contact with one another first and then the piston 120 is tightly attached to one surface 191′. Like the protrusions 193′, the grooves 194′ are provided as a plurality of grooves 194′ formed on the other surface 192′ and spaced apart from one another by a preset angle in the circumferential direction of the stopper member 190′.

The return means 150′ includes the first elastic member 151, the boot 152, the retainer 153, and a second elastic member 154′. Because the first elastic member 151, the boot 152, and the retainer 153 are identical to those in the above-mentioned embodiment, a detailed description thereof will be omitted.

The second elastic member 154′ is provided in the cylinder body 110′. Specifically, the second elastic member is provided in the second hole 111b′. One side of the second elastic member 154′ is connected to the piston 120′, and the other side of the second elastic member 154′ is connected to the cover member 180′ and provided to surround the damper 130. Like the first elastic member 151, the second elastic member 154′ is configured as a spring.

The second elastic member 154′ is compressed when the piston 120′ is moved forward by the pedal (not illustrated). When a force, which moves the piston 120′ forward, is eliminated, a tensile force of the second elastic member 154′ is generated to move the piston 120′ rearward and return the piston 120′ to an initial position.

The return means 150′ further includes the second elastic member 154′ to provide a force to return the piston 120′ when the first elastic member 151 is damaged.

The ventilation means 160′ is provided so that air is allowed to flow by a change in volume of the cylinder body 110′, a change in volume of the hole portion 111′, and a change in volume of the boot 152 when the piston 120′ moves forward and rearward.

The ventilation means 160′ includes a first vent flow path 161′, a second vent flow path 162′, and a third vent flow path 163′. The first vent flow path 161′ is identical to that in the above-mentioned embodiment and formed in the first hole 111a′ of the cylinder body 110′.

When the piston 120′ moves forward, the air in the second hole 111b′ of the cylinder body 110′ flows into the boot 152 through the first vent flow path 161′. When the piston 120′ moves rearward, the air in the boot 152 flows to the second hole 111b′ of the cylinder body 110′ through the first vent flow path 161′.

The first vent flow path 161′ may be formed in the outer peripheral surface of the piston 120′.

The second vent flow path 162′ is formed so that when the piston 120′ moves forward, the air in the boot 152 is discharged to the outside or outside air is introduced into the boot 152. The second vent flow path 162′ is formed to be directed toward an outer peripheral surface of the cylinder body 110′ from one side of the cylinder body 110′ connected to the boot 152.

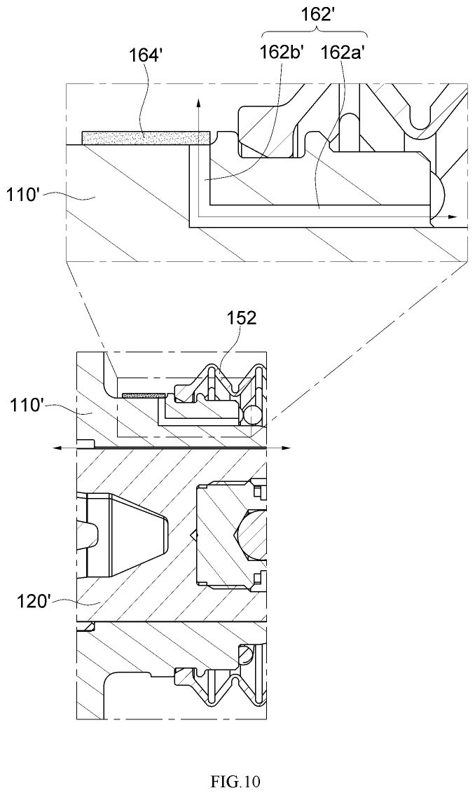

FIG. 10 illustrates a detailed structure of the second vent flow path 162′. With reference to FIG. 10, the second vent flow path 162′ includes a first flow path 162a′ extending in the longitudinal direction of the cylinder body 110′ from one side of the cylinder body 110′ connected to the boot 152, and a second flow path 162b′ extending from an end of the first flow path 162a′ in a direction intersecting the first flow path 162a′, the second flow path 162b′ being directed toward the outer peripheral surface of the cylinder body 110′.

Therefore, the air, which stays in the boot 152, flows along the second vent flow path 162′ and is discharged to the outside. In addition, outside air is introduced into the boot 152 through the second vent flow path 162′.

The ventilation means 160′ further includes a filter member 164′. The filter member 164′ is provided while surrounding the outer peripheral surface of the cylinder body 110′. As illustrated in FIG. 10, the filter member 164′ is provided to cover the second vent flow path 162′. Therefore, the air, which is introduced into the second vent flow path 162′ from the outside, passes through the filter member 164′, such that foreign substances in the air may be filtered out, and foreign substances are prevented from being introduced into the boot 152.

The third vent flow path 163′ is formed to be spaced apart from the first vent flow path 162′. The third vent flow path 163′ may be formed so that when the piston 120′ moves forward, the air in the second hole 111b′ of the cylinder body 110′ is discharged to the outside or outside air is introduced into the second hole 111b′ of the cylinder body 110′.

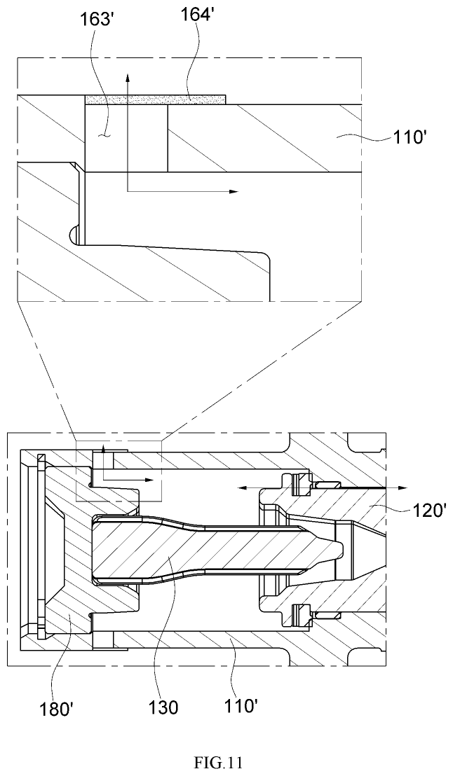

FIG. 11 illustrates the third vent flow path 163′ in detail. With reference to FIG. 11, the third vent flow path 163′ is formed at a position spaced apart from the other side of the cylinder body 110′ by a preset distance in a direction toward one side. The third vent flow path 163′ is formed through the cylinder body 110′ in the direction intersecting the longitudinal direction. Therefore, the inside and outside of the cylinder body 110′ communicate with each other through the second hole 111b′.

The air, which stays in the cylinder body 110′, is discharged to the outside of the cylinder body 110′ through the third vent flow path 163′. In contrast, outside air is introduced into the cylinder body 110′ through the third vent flow path 163′.

The third vent flow path 163′ is covered by the filter member 164′ provided while surrounding the outer peripheral surface of the cylinder body 110′. That is, after foreign substances are removed as outside air passes through the filter member 164′, the outside air is introduced into the cylinder body 110′.

The second vent flow path 162′ and the third vent flow path 163′ are formed to prevent the occurrence of noise because only the first vent flow path 161′ cannot compensate for the change in volume of the boot 152 and the change in volume of the second hole 111b′ when the piston 120′ moves forward.

In the related art, because a pedal simulator is integrated with an electric booster (not illustrated), the pedal simulator may be connected to a pedal when the electric booster is coupled to a firewall in a vehicle. In particular, in this case, there is a problem in that the pedal needs to be a pedal, which defines a circular trajectory downward, so as to be connected to the pedal simulator, a space in an engine room needs to be ensured, and a plurality of (two) assembling operators is required. That is, it is difficult to apply the pedal simulator to an organ type pedal.

The pedal simulator according to the present embodiment is separated from the electric booster, such that the pedal simulator may be connected to even an organ type pedal. The organ type pedal is a pedal that defines a circular trajectory upward. The pedal simulator 100 or 100′ according to the present embodiment has a degree of installation freedom, such that the pedal simulator 100 or 100′ may be disposed and assembled to be inclined downward by a preset angle with respect to an imaginary horizontal line passing through an axis along which the organ type pedal (not illustrated) and the pedal simulator 100 or 100′ are connected.

The organ-type pedal (not illustrated) may be installed by a single operator, which may improve assembling conditions.

While the embodiments of the present disclosure have been described with reference to the accompanying drawings, those skilled in the art will understand that the present disclosure may be carried out in any other specific form without changing the technical spirit or an essential feature thereof.

Accordingly, it should be understood that the aforementioned embodiments are described for illustration in all aspects and is not limited, and the scope of the present disclosure shall be represented by the claims to be described below, and it should be construed that all of the changes or modified forms induced from the meaning and the scope of the claims, and an equivalent concept thereto are included in the scope of the present disclosure.

1. A pedal simulator comprising:
a cylinder body having an internal space formed as one side is opened, and the other side is closed;
a piston configured to move forward and rearward in the internal space of the cylinder body in conjunction with an operation of a pedal;
a damper provided in the internal space of the cylinder body and configured to transfer pedal feel to an electric booster by means of a pressure applied from the piston;
a push rod having one side connected to the pedal, and the other side connected to the piston, the push rod being configured to move the piston forward toward the damper in conjunction with the operation of the pedal; and
a return means provided while covering one side of the cylinder body and a part of the push rod and configured to provide a restoring force for moving rearward the push rod that has moved forward.

2. The pedal simulator of claim 1, wherein the return means comprises:
a first elastic member connected to one side of the cylinder body while covering the push rod and configured to move the push rod rearward by an elastic force;
a boot coupled to one side of the cylinder body while covering the first elastic member and configured to be contracted and expanded by the forward and rearward movements of the piston; and
a retainer penetrated by the push rod and coupled to block one side of the boot.

3. The pedal simulator of claim 2, wherein one or more vent holes are formed in the retainer to allow the inside and outside of the boot so that air in the boot is discharged or outside air is introduced into the boot.

4. The pedal simulator of claim 1, wherein the cylinder body further comprises blade portions extending from an outer peripheral surface of the cylinder body in a direction intersecting a longitudinal direction of the cylinder body, and
wherein the blade portions are provided as a pair of blade portions formed to be symmetric based on a central axis that penetrates the cylinder body in the longitudinal direction of the cylinder body.

5. The pedal simulator of claim 4, wherein a through-hole is formed in the blade portion in a direction parallel to the longitudinal direction of the cylinder body.

6. The pedal simulator of claim 5, further comprising:
a fastening member penetratively inserted in the through-hole and configured to fix the cylinder body to a vehicle.

7. The pedal simulator of claim 6, wherein the fastening member comprises:
a head portion partially penetratively inserted in the through-hole; and
an insertion fixing portion extending from one surface of the head portion and inserted in the vehicle to fix the cylinder body.

8. The pedal simulator of claim 2, further comprising:
a ventilation means configured to allow air to flow in accordance with a change in volume of the internal space of the cylinder body and a change in volume of and the boot when the piston moves forward and rearward.

9. The pedal simulator of claim 8, wherein the ventilation means comprises a vent flow path formed in any one of the cylinder body and the piston.

10. The pedal simulator of claim 9, wherein the vent flow path is formed in an inner peripheral surface of the cylinder body, and the vent flow path is formed in the form of a slot concavely formed by a preset length toward the other side of the cylinder body from a position spaced apart from one side of the cylinder body by a preset distance.

11. A pedal simulator comprising:
a cylinder body having a hole portion formed through the cylinder body in a longitudinal direction;
a piston inserted in one side of the hole portion of the cylinder body and configured to move forward and rearward in conjunction with an operation of a pedal;
a cover member inserted in the other side of the hole portion of the cylinder body to block the other side of the cylinder body;
a damper coupled to the cover member and provided in the hole portion of the cylinder body to transfer pedal feel to an electric booster by means of a pressure applied from the piston;
a push rod having one side connected to the pedal, and the other side connected to the piston, the push rod being configured to move the piston forward toward the damper in conjunction with the operation of the pedal; and
a return means provided while covering one side of the cylinder body and a part of the push rod and configured to provide a restoring force for moving rearward the push rod that has moved forward.

12. The pedal simulator of claim 11, wherein the hole portion comprises:
a first hole formed through the cylinder body by a preset length from one side toward the other side of the cylinder body in the longitudinal direction of the cylinder body; and
a second hole formed through the cylinder body from an end of the first hole to the other side of the cylinder body, and
wherein a cross-section of the second hole intersecting the longitudinal direction of the cylinder body is larger than a cross-section of the first hole intersecting the longitudinal direction of the cylinder body.

13. The pedal simulator of claim 12, wherein the return means comprises:
a first elastic member connected to one side of the cylinder body while covering the push rod and configured to move the push rod rearward by an elastic force;
a boot coupled to one side of the cylinder body while covering the first elastic member and configured to be contracted and expanded by the forward and rearward movements of the piston;
a retainer configured to penetrate the push rod and coupled to block one side of the boot; and
a second elastic member having one side connected to the piston while covering the damper, and the other side connected to the cover member and provided in the second hole, the second elastic member being configured to move the piston rearward by an elastic force.

14. The pedal simulator of claim 13, further comprising:
a ventilation means provided to allow air to flow in accordance with a change in volume of a hole portion of the cylinder body and a change in volume of the boot by the forward and rearward movements of the piston.

15. The pedal simulator of claim 14, wherein the ventilation means further comprises a first vent flow path formed in any one of the cylinder body and the piston so that air in the hole portion of the cylinder body flows into the boot when the piston moves forward, or air in the boot flows to the hole portion of the cylinder body when the piston moves rearward.

16. The pedal simulator of claim 14, wherein the ventilation means further comprises a second vent flow path extending from one side of the cylinder body in the longitudinal direction of the cylinder body and formed through an outer peripheral surface of the cylinder body so that when the piston moves forward, air in the boot is discharged to the outside or outside air is introduced into the boot.

17. The pedal simulator of claim 14, wherein the ventilation means further comprises a third vent flow path penetratively formed from the hole portion of the cylinder body to the outside so that when the piston moves forward, air in the hole portion of the cylinder body is discharged to the outside or outside air is introduced into the hole portion of the cylinder body.

18. The pedal simulator of claim 17, wherein the ventilation means further comprises a filter member provided while covering an outer peripheral surface of the cylinder body so as to cover the second vent flow path and the third vent flow path, the filter member being configured to remove foreign substances in air.

19. The pedal simulator of claim 12, further comprising:
a stopper member provided between the piston and the first hole and configured to absorb an impact and prevent noise when the impact and noise are generated by the forward and rearward movements of the piston.

20. The pedal simulator of claim 11, wherein the cylinder body further comprises blade portions extending from an outer peripheral surface of the cylinder body in a direction intersecting a longitudinal direction of the cylinder body, and
wherein the blade portions are provided as a pair of blade portions formed to be symmetric based on a central axis that penetrates the cylinder body in the longitudinal direction of the cylinder body.

21.-22. (canceled)
